(19) United States
(12) Patent Application Publication
(10) Pub. No.: US 2009/0182095 A1
(43) Pub. Date: Jul. 16, 2009

(54) Process for production of peroxide curable high multiolefin halobutyl ionomers

(75) Inventors: Rui Resendes, Kingston (CA); Janice Nicole Hickey, Hamilton (CA)

Correspondence Address: LANXESS CORPORATION, 111 RIDC PARK WEST DRIVE, PITTSBURGH, PA, 15275-1112, US

(73) Assignee: Lanxess Inc., Sarnia, Ontario (CA)

(21) Appl. No.: 11/990,823

(22) PCT Filed: Aug. 16, 2006
(86) PCT No.: PCT/CA2006/001342

§ 371 Date: Jan. 6, 2009

Related U.S. Application Data
(60) Provisional application No. 60/711,764, filed on Aug. 26, 2005.

(51) Int. Cl. C08F 8/22

(52) U.S. Cl. 525/332.3

(57) ABSTRACT

The present invention relates to a process for producing peroxide curable high multiolefin halobutyl ionomers prepared by reacting a halogenated butyl polymer having a high mol percent of multiolefin with at least one nitrogen and/or phosphorus based nucleophile. The resulting high multiolefin halobutyl ionomer comprises from about 2 to 10 mol % multiolefin. The present invention is also directed to the high multiolefin halobutyl ionomer.

### FIELD OF THE INVENTION

The present invention relates to a process for producing peroxide curable butyl ionomers prepared by reacting a halogenated butyl polymer having a high mol percent of multiolefin with at least one nitrogen and/or phosphorus based nucleophile.

### BACKGROUND OF THE INVENTION

Poly(isobutylene-co-isoprene), or IIR, is a synthetic elastomer commonly known as butyl rubber which has been prepared since the 1940's through the random cationic copolymerization of isobutylene with small amounts of isoprene. The resulting commercially available IIR, hereinafter referred to as non-high multiolefin IIR has a multiolefin content of between 1 and 2 mol %. As a result of its molecular structure, the non-high multiolefin containing IIR possesses superior air impermeability, a high loss modulus, oxidative stability and extended fatigue resistance (see Chu, C. Y. and Vukov, R., Macromolecules, 18, 1423-1430, 1985).

Historically the low unsaturation content of non-high multiolefin IIR can support sufficient vulcanization activity for tire inner tubes, it is insufficient for the purposes of tire inner liner applications. For this reason, the vulcanization rate of non-high multiolefin IIR must be accelerated by halogenation to yield a reactive allylic halide functionality within the elastomer. Once halogenated the non-high multiolefin containing XIIR contains allylic halide functionalities which allows for nucleophilic alkylation reactions with these polymer bound allylic halides.

It has been recently shown that treatment of non-high multiolefin brominated butyl rubber with nitrogen and/or phosphorus based nucleophiles, in the solid state, leads to the generation of non-high multiolefin butyl based ionomers with interesting physical and chemical properties (see Parent, J. S.; Liskova, A.; Whitney, R. A.; Resendes, R. Journal of Polymer Science, Part A: Polymer Chemistry (Accepted Jul. 26, 2005), Parent, J. S.; Liskova, A.; Resendes, R. Polymer 45, 8091-8096, 2004, Parent, J. S.; Penciu, A.; Guillen-Castellanos, S. A.; Liskova, A.; Whitney, R. A. Macromolecules 37, 7477-7483, 2004). As disclosed therein, the non-high multiolefin butyl rubber suitable for treatment with nitrogen and/or phosphorous based nucleophiles has a multiolefin (isoprene) content of between 0.05 and 0.4 mole percent.

Peroxide curable rubber compounds offer several advantages over conventional, sulfur-curing, systems. Typically, these compounds display extremely fast cure rates and the resulting cured articles tend to possess excellent heat resistance. In addition, peroxide-curable formulations are considered to be “clean” in that they do not contain any extractable inorganic impurities (e.g. sulfur). The clean rubber articles can therefore be used, for example, in condenser caps, biomedical devices, pharmaceutical devices (stoppers in medicine-containing vials, plungers in syringes) and possibly in seals for fuel cells.

It is well accepted that polyisobutylene and non-high multiolefin butyl rubber decompose under the action of organic peroxides. Furthermore, U.S. Pat. Nos. 3,862,265 and 4,749,505 disclose that copolymers of a C₄ to C₇ isomonoolefin with up to 10 wt. % isoprene or up to 20 wt. % para-alkylstyrene undergo a molecular weight decrease when subjected to high shear mixing. This effect is enhanced in the presence of free radical initiators, such as peroxides. Recently, the preparation of butyl-based, peroxide-curable compounds which employ the use of novel grades of high isoprene (IP) butyl rubber, has been illustrated in a continuous process. Specifically, CA 2,418,884 describes the continuous preparation of butyl rubber with isoprene levels ranging from 3 to 8 mol %. With these elevated levels of isoprene now available, it is surprisingly possible, to generate halogenated butyl rubber analogues which contain allylic halide functionalities ranging from 3 to 8 mol %. By utilizing the reactive allylic halide functionalities present, it is possible to prepare butyl based ionomeric species and ultimately optimize the levels of residual multiolefin thereby facilitating the peroxide cure of formulations based on this material.

### SUMMARY OF THE INVENTION

The present invention relates to a method for preparing peroxide curable butyl based ionomers from novel grades of high multiolefin containing halogenated butyl rubber. Accordingly, the present invention provides a process for producing butyl ionomers by (a) polymerizing at least one isoolefin monomer, at least one multiolefin monomer and optionally further copolymerizable monomers in the presence of AlCl₃ and a proton source and/or cationogen capable of initiating the polymerization process and at least one multiolefin cross-linking agent to prepare a high multiolefin butyl polymer, then (b) halogenating the high multiolefin butyl polymer and (c) reacting the high multiolefin halobutyl polymer with at least one nitrogen and/or phosphorous based nucleophile.

The butyl ionomer prepared according to this process possesses nitrogen and/or phosphorus alkylated allylic halides, otherwise known as ionomeric moieties, in place of the original unalkylated allylic halides present in halobutyl polymers. Accordingly, the present invention also provides a butyl ionomer containing from about 0.05 to 2.0 mol % of the ionomeric moiety and from 2 to 10 mol % of a multiolefin.

### DETAILED DESCRIPTION OF THE INVENTION

### Preparation of High Multiolefin Butyl Polymers

The high multiolefin butyl polymer useful in the preparation of the butyl ionomer according to the present invention is derived from at least one isoolefin monomer, at least one multiolefin monomer and optionally further copolymerizable monomers.

The present invention is not limited to a special isoolefin. However, isoolefins within the range of from 4 to 16 carbon atoms, preferably 4-7 carbon atoms, such as isobutene, 2-methyl-1-butene, 3-methyl-1-butene, 2-methyl-2-butene, 4-methyl-1-pentene and mixtures thereof are preferred. More preferred is isobutene.

The present invention is not limited to a special multiolefin. Every multiolefin copolymerizable with the isoolefin known by the skilled in the art can be used. However, multiolefins with in the range of from 4-14 carbon atoms, such as isoprene, butadiene, 2-methylbutadiene, 2,4-dimethylbutadiene, piperyline, 3-methyl-1,3-pentadiene, 2,4-hexadiene, 2-neopentylbutadiene, 2-methly-1,5-hexadiene, 2,5-dimethly-2,4-hexadiene, 2-methyl-1,4-pentadiene, 2-methyl-1,6-heptadiene, cyclopenta-diene, methylcyclopentadiene, cyclohexadiene, 1-vinyl-cyclohexadiene and mixtures thereof, preferably conjugated dienes, are used. Isoprene is more preferably used.

In the present invention, β-pinene can also be used as a co-monomer for the isoolefin.

As optional monomers, any monomer copolymerizable with the isoolefins and/or dienes known by the skilled in the art can be used. α-methyl styrene, p-methyl styrene, chlorostyrene, cyclopentadiene and methylcyclopentadiene are preferably used. Indene and other styrene derivatives may also be used in the present invention.

Preferably, the monomer mixture to prepare the high multiolefin butyl polymer contains in the range of from 80% to 95% by weight of at least one isoolefin monomer and in the range of from 4.0% to 20% by weight of at least one multiolefin monomer and/or β-pinene and in the range of from 0.01% to 1% by weight of at least one multiolefin cross-linking agent. More preferably, the monomer mixture contains in the range of from 83% to 94% by weight of at least one isoolefin monomer and in the range of from 5.0% to 17% by weight of a multiolefin monomer or β-pinene and in the range of from 0.01% to 1% by weight of at least one multiolefin cross-linking agent. Most preferably, the monomer mixture contains in the range of from 85% to 93% by weight of at least one isoolefin monomer and in the range of from 6.0% to 15% by weight of at least one multiolefin monomer, including β-pinene and in the range of from 0.01% to 1% by weight of at least one multiolefin cross-linking agent.

The weight average molecular weight of the high multiolefin butyl polymer (M_{w}), is preferably greater than 240 kg/mol, more preferably greater than 300 kg/mol, even more preferably greater than 500 kg/mol, most preferably greater than 600 kg/mol.

The gel content of the high multiolefin butyl polymer is preferably less than 10 wt. %, more preferably less than 5 wt %, even more preferably less than 3 wt %, most preferably less than 1 wt %. In connection with the present invention the term “gel” is understood to denote a fraction of the polymer insoluble for 60 min in cyclohexane boiling under reflux.

The polymerization of the high multiolefin butyl polymer is performed in the presence of AlCl₃ and a proton source and/or cationogen capable of initiating the polymerization process. A proton source suitable in the present invention includes any compound that will produce a proton when added to AlCl₃ or a composition containing AlCl₃. Protons may be generated from the reaction of AlCl₃ with proton sources such as water, alcohol or phenol to produce the proton and the corresponding by-product. Such reaction may be preferred in the event that the reaction of the proton source is faster with the protonated additive as compared with its reaction with the monomers. Other proton generating reactants include thiols, carboxylic acids, and the like. According to the present invention, when low molecular weight high multiolefin butyl polymer is desired an aliphatic or aromatic alcohol is preferred. The most preferred proton source is water. The preferred ratio of AlCl₃ to water is between 5:1 to 100:1 by weight. It may be advantageous to further introduce AlCl₃ derivable catalyst systems, diethylaluminium chloride, ethylaluminium chloride, titanium tetrachloride, stannous tetrachloride, boron trifluoride, boron trichloride, or methylalumoxane.

In addition or instead of a proton source a cationogen capable of initiating the polymerization process can be used. Suitable cationogen includes any compound that generates a carbo-cation under the conditions present. A preferred group of cationogens include carbocationic compounds having the formula:

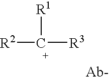

wherein R¹, R² and R³, are independently hydrogen, or a linear, branched or cyclic aromatic or aliphatic group, with the proviso that only one of R¹, R² and R³ may be hydrogen. Preferably, R¹, R² and R³, are independently a C₁ to C₂₀ aromatic or aliphatic group. Non-limiting examples of suitable aromatic groups may be selected from phenyl, tolyl, xylyl and biphenyl. Non-limiting examples of suitable aliphatic groups include methyl, ethyl, propyl, butyl, pentyl, hexyl, octyl, nonyl, decyl, dodecyl, 3-methylpentyl and 3,5,5-trimethylhexyl.

Another preferred group of cationogens includes substituted silylium cationic compounds having the formula:

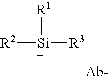

wherein R¹, R² and R³, are independently hydrogen, or a linear, branched or cyclic aromatic or aliphatic group, with the proviso that only one of R¹, R² and R³ may be hydrogen. Preferably, none of R¹, R² and R³ is H. Preferably, R¹, R² and R³ are, independently, a C₁ to C₂₀ aromatic or aliphatic group. More preferably, R¹, R² and R³ are independently a C₁ to C₈ alkyl group. Examples of useful aromatic groups may be selected from phenyl, tolyl, xylyl and biphenyl. Non-limiting examples of useful aliphatic groups include methyl, ethyl, propyl, butyl, pentyl, hexyl, octyl, nonyl, decyl, dodecyl, 3-methylpentyl and 3,5,5-trimethylhexyl. A preferred group of reactive substituted silylium cations include trimethylsilylium, triethylsilylium and benzyldimethylsilylium. Such cations may be prepared, for example, by the exchange of the hydride group of the R¹R²R³Si—H with a non-coordinating anion (NCA), such as Ph₃C+B(pfp)₄-yielding compositions such as R¹R²R³SiB(pfp)₄ which in the appropriate solvent obtain the cation.

According to the present invention, Ab- denotes an anion. Preferred anions include those containing a single coordination complex possessing a charge bearing metal or metalloid core which is negatively charged to the extent necessary to balance the charge on the active catalyst species which may be formed when the two components are combined. More preferably Ab- corresponds to a compound with the general formula [MQ4]- wherein

M is a boron, aluminum, gallium or indium in the +3 formal oxidation state; and
Q is independently selected from hydride, dialkylamido, halide, hydrocarbyl, hydrocarbyloxide, halo-substituted hydrocarbyl, halo-substituted hydrocarbyloxide, and halo-substituted silylhydrocarbyl radicals.

Preferably, there are no organic nitro compounds or transition metals used in the process according to the present invention.

The reaction mixture used to produce the high multiolefin containing butyl polymer further contains a multiolefin cross-linking agent. The term cross-linking agent is known to those skilled in the art and is understood to denote a compound that causes chemical cross-linking between the polymer chains in opposition to a monomer that will add to the chain. Some easy preliminary tests will reveal if a compound will act as a monomer or a cross-linking agent. The choice of the cross-linking agent is not restricted. Preferably, the cross-linking contains a multiolefinic hydrocarbon compound. Examples of these include norbornadiene, 2-isopropenylnorbornene, 2-vinyl-norbornene, 1,3,5-hexatriene, 2-phenyl-1,3-butadiene, divinylbenzene, diisopropenylbenzene, divinyltoluene, divinylxylene and C₁ to C₂₀ alkyl-substituted derivatives thereof. More preferably, the multiolefin crosslinking agent is divinyl-benzene, diisopropenylbenzene, divinyltoluene, divinyl-xylene and C₁ to C₂₀ alkyl substituted derivatives thereof, and or mixtures of the compounds given. Most preferably the multiolefin crosslinking agent contains divinylbenzene and diisopropenylbenzene.

The polymerization of the high multiolefin containing butyl polymer can be performed in a continuous process in slurry (suspension), in a suitable diluent, such as chloroalkanes as described in U.S. Pat. No. 5,417,930.

The monomers are generally polymerized cationically, preferably at temperatures in the range from −120° C. to +20° C., preferably in the range from −100° C. to −20° C., and pressures in the range from 0.1 to 4 bar.

The use of a continuous reactor as opposed to a batch reactor seems to have a positive effect on the process. Preferably, the process is conducted in at least one continuous reactor having a volume of between 0.1 m³ and 100 m³, more preferable between 1 m³ and 10 m³.

Inert solvents or diluents known to the person skilled in the art for butyl polymerization may be considered as the solvents or diluents (reaction medium). These include alkanes, chloroalkanes, cycloalkanes or aromatics, which are frequently also mono- or polysubstituted with halogens. Hexane/chloroalkane mixtures, methyl chloride, dichloromethane or the mixtures thereof may be preferred. Chloroalkanes are preferably used in the process according to the present invention.

Polymerization is preferably performed continuously. The process is preferably performed with the following three feed streams:

I) solvent/diluent+isoolefin (preferably isobutene)+multiolefin (preferably diene, isoprene)
II) initiator system
III) multiolefin cross-linking agent

It should be noted that the multiolefin crosslinking agent can also be added in the same feed stream as the isoolefin and multiolefin.

### Preparation of the High Multiolefin Halobutyl

The resulting high multiolefin butyl polymer can then be subjected to a halogenation process in order to produce high multiolefin halobutyl polymers. Bromination or chlorination can be performed according to the process known by those skilled in the art, such as, the procedures described in Rubber Technology, 3rd Ed., Edited by Maurice Morton, Kluwer Academic Publishers, pp. 297-300 and references cited within this reference.

The resulting high multiolefin halobutyl polymer should have a total allylic halide content from 0.05 to 2.0 mol %, more preferably from 0.2 to 1.0 mol % and even more preferably from 0.5 to 0.8 mol %. The high multiolefin halobutyl polymer should also contain residual multiolefin levels ranging from 2 to 10 mol %, more preferably from 3 to 8 mol % and even more preferably from 4 to 7.5 mol %.

### Preparation of the High Multiolefin Butyl Ionomer

According to the process of the present invention, the high multiolefin halobutyl polymer can then be reacted with at least one nitrogen and/or phosphorus containing nucleophile according to the following formula:

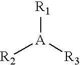

wherein A is a nitrogen or phosphorus,
R₁, R₂ and R₃ are selected from the group consisting of linear or branched C₁-C₁₈ alkyl substituents, an aryl substituent which is monocyclic or composed of fused C₄-C₈ rings, and/or a hetero atom selected from, for example, B, N, O, Si, P, and S.

In general, the appropriate nucleophile will contain at least one neutral nitrogen or phosphorus center which possesses a lone pair of electrons which is both electronically and sterically accessible for participation in nucleophilic substitution reactions. Suitable nucleophiles include trimethylamine, triethylamine, triisopropylamine, tri-n-butylamine, trimethylphosphine, triethylphosphine, triisopropylphosphine, tri-n-butylphosphine, and triphenylphosphine.

According to the present invention, the amount of nucleophile reacted with the high multiolefin butyl rubber is in the range from 1 to 5 molar equivalents, more preferable 1.5 to 4 molar equivalents and even more preferably 2 to 3 molar equivalents based on the total molar amount of allylic halide present in the high multiolefin halobutyl polymer.

The high multiolefin halobutyl polymer and the nucleophile can be reacted for about 10 to 90 minutes, preferably from 15 to 60 minutes and more preferably from 20 to 30 minutes at temperatures ranging from 80 to 200° C., preferably from 90 to 160° C. and more preferably from 100 to 140° C.

The resulting high multiolefin halobutyl based ionomer preferably possesses from 0.05 to 2.0 mol %, more preferably from 0.2 to 1.0 mol % and even more preferably from 0.5 to 0.8 mol % of the ionomeric moiety and from 2 to 10 mol %, more preferably from 3 to 8 mol % and even more preferably from 4 to 7.5 mol % of multiolefin.

According to the present invention the resulting ionomer could also be a mixture of the polymer-bound ionomeric moiety and allylic halide such that the total molar amount of ionomeric moiety and allylic halide functionality are present in the range of 0.05 to 2.0 mol %, more preferably from 0.2 to 1.0 mol % and even more preferably from 0.5 to 0.8 mol % with residual multiolefin being present in the range from 0.2 to 1.0 mol % and even more preferably from 0.5 to 0.8 mol %.

The following Examples are provided to illustrate the present invention:

### EXAMPLES

Equipment: ¹H NMR spectra were recorded with a Bruker DRX500 spectrometer (500.13 MHz ¹H) in CDCl₃ with chemical shifts referenced to tetramethylsilane.

Materials: All reagents, unless otherwise specified, were used as received from Sigma-Aldrich (Oakville, Ontario, Canada). BIIR (BB2030) was used as supplied by LANXESS Inc. Epoxidized soya-bean oil (L. V. Lomas) and Irganox 1076 (CIBA Canada Ltd.) were used as received from their respective suppliers.

### Example 1

### Preparation of High Isoprene BIIR

110 mL of elemental bromine was added to a solution of 7 kg of 6.5 mol % of 1,4 high isoprene butyl polymer prepared according to Example 2 of CA 2,418,884 in 31.8 kg of hexanes and 2.31 kg of water in a 95 L reactor with rapid agitation. After 5 minutes, the reaction was terminated via the addition of a caustic solution of 76 g of NaOH in 1 L of water. Following an additional 10 minutes of agitation, a stabilizer solution of 21.0 g of epoxidized soya-bean oil and 0.25 g of Irganox® 1076 in 500 mL of hexanes and one of 47.0 g of epoxidized soya-bean oil and 105 g of calcium stearate in 500 mL of hexanes was added to the reaction mixture. After an additional 1 h of agitation, the high multiolefin butyl polymer was isolated by steam coagulation. The final material was dried to a constant weight with the use of a two roll 10″×20″ mill operating at 100° C. The microstructure of the resulting material is presented in Table 1.

### Example 2

### Preparation of High Isoprene IIR Ionomer

48 g of Example 1 and 4.7 g (3 molar equivalents based on allylic bromide content of Example 1) of triphenylphosphine were added to a Brabender internal mixer (Capacity 75 g) operating at 100° C. and a rotor speed of 60 RPM. Mixing was carried out for a total of 60 minutes. Analysis of the final product by ¹H NMR confirmed the complete conversion of all the allylic bromide sites of Example 1 to the corresponding ionomeric species. The resulting material was also found to possess ca. 4.20 mol % of 1,4-isoprene.

TABLE 1

| | |
|---|---|
| Total Unsats (mol %) | 5.79 |
| 1,4 Isoprene (mol %) | 4.19 |
| Branched Isoprene (mol %) | 0.32 |
| Allylic Bromide (mol %) | 0.71 |
| Conjugated Diene (mol %) | 0.04 |
| Endo Br (mol %) | 0.07 |

As can be seen from the examples described above, the treatment of a high isoprene analogue of brominated butyl polymer (Example 1) with a neutral phosphorus based nucleophile results in the formation of the corresponding high isoprene butyl ionomer (Example 2). The method described in Example 2 is of general applicability and can be used to generate high isoprene, peroxide curable, butyl ionomers from high isoprene brominated polymer and neutral phosphorus and/or nitrogen based nucleophiles.

What is claimed is:

1. A process for the production of a high multiolefin halobutyl ionomer comprising:
(a) polymerizing a monomer mixture comprising at least one isoolefin monomer, at least one multiolefin monomer and optionally further copolymerizable monomers in the presence of AlCl₃ and a proton source and/or cationogen capable of initiating the polymerization process and at least one multiolefin cross-linking agent to prepare a high multiolefin butyl polymer, then
(b) halogenating the high multiolefin butyl polymer and
(c) reacting the high multiolefin halobutyl polymer with at least one nitrogen and/or phosphorous based nucleophile.

2. The process according to claim 1, wherein the nucleophile is of the general formula: 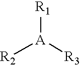
wherein A is a nitrogen or phosphorus, R₁, R₂ and R₃ is selected from the group consisting of linear or branched C₁-C₁₈ alkyl substituents, an aryl substituent which is monocyclic or composed of fused C₄-C₈ rings, and/or a hetero atom selected from, for example, B, N, O, Si, P, and S.

3. The process according to claim 1, wherein the monomer mixture comprises 80% to 95% by weight of at least one isoolefin monomer and in the range of from 4.0% to 20% by weight of at least one multiolefin monomer and/or β-pinene and in the range of from 0.01% to 1% by weight of at least one multiolefin cross-linking agent.

4. The process according to claim 3, wherein the monomer mixture comprises in the range of from 83% to 94% by weight of at least one isoolefin monomer and in the range of from 5.0% to 17% by weight of a multiolefin monomer or β-pinene and in the range of from 0.01% to 1% by weight of at least one multiolefin cross-linking agent.

5. The process according to claim 3, wherein the monomer mixture comprises in the range of from 85% to 93% by weight of at least one isoolefin monomer and in the range of from 6.0% to 15% by weight of at least one multiolefin monomer, including β-pinene and in the range of from 0.01% to 1% by weight of at least one multiolefin cross-linking agent.

6. The process according to claim 1, wherein the isoolefin is selected from the group consisting of isobutene, 2-methyl-1-butene, 3-methyl-1-butene, 2-methyl-2-butene, 4-methyl-1-pentene and mixtures thereof.

7. The process according to claim 1, wherein the multiolefin is selected from the group consisting of isoprene, butadiene, 2-methylbutadiene, 2,4-dimethylbutadiene, piperyline, 3-methyl-1,3-pentadiene, 2,4-hexadiene, 2-neopentylbutadiene, 2-methly-1,5-hexadiene, 2,5-dimethly-2,4-hexadiene, 2-methyl-1,4-pentadiene, 2-methyl-1,6-heptadiene, cyclopenta-diene, methylcyclopentadiene, cyclohexadiene, 1-vinyl-cyclohexadiene and mixtures thereof.

8. The process according to claim 1, wherein the crosslinking agent is selected from the group consisting of norbornadiene, 2-isopropenylnorbornene, 2-vinyl-norbornene, 1,3,5-hexatriene, 2-phenyl-1,3-butadiene, divinylbenzene, diisopropenylbenzene, divinyltoluene, divinylxylene and C₁ to C₂₀ alkyl-substituted derivatives thereof.

9. The process according to claim 1, wherein the high multiolefin butyl polymer is halogenated with bromine or chloride.

10. The process according to claim 1, wherein the nucleophile is selected from the group consisting of trimethylamine, triethylamine, triisopropylamine, tri-n-butylamine, trimethylphosphine, triethylphosphine, triisopropylphosphine, tri-n-butylphosphine, triphenylphosphine and mixtures thereof.

11. The process according to claim 1, wherein the high multiolefin butyl ionomer comprises from about 2 to 10 mol % multiolefin.

12. The process according to claim 1, wherein the high multiolefin butyl ionomer comprises from about 4 to 7.5 mol % multiolefin.

13. A high multiolefin halobutyl ionomer prepared according to the process of claim 1.

14. The high multiolefin halobutyl ionomer according to claim 13, wherein the ionomer comprises from 2 to 10 mol % multiolefin.

15. The high multiolefin halobutyl ionomer according to claim 14, wherein the ionomer comprises from about 4 to 7.5 mol % multiolefin.

16. The high multiolefin halobutyl ionomer according to claim 15, wherein the multiolefin is selected from the group consisting of isoprene, butadiene, 2-methylbutadiene, 2,4-dimethylbutadiene, piperyline, 3-methyl-1,3-pentadiene, 2,4-hexadiene, 2-neopentylbutadiene, 2-methly-1,5-hexadiene, 2,5-dimethly-2,4-hexadiene, 2-methyl-1,4-pentadiene, 2-methyl-1,6-heptadiene, cyclopenta-diene, methylcyclopentadiene, cyclohexadiene, 1-vinyl-cyclohexadiene and mixtures thereof.

17. The high multiolefin halobutyl ionomer according to claim 15, wherein the multiolefin is isoprene.
